(19) United States
(12) Patent Application Publication
(10) Pub. No.: US 2023/0141108 A1
(43) Pub. Date: May 11, 2023

(54) SEASONING BOX AND MOUNTING ASSEMBLY THEREOF

(71) Applicant: Shenzhen City Itas in-tech Sanitary Wares Co.,Limited, Shenzhen (CN)

(72) Inventor: Yingcai Gui, Shenzhen (CN)

(73) Assignee: Shenzhen City Itas in-tech Sanitary Wares Co.,Limited, Shenzhen (CN)

(21) Appl. No.: 18/093,339

(22) Filed: Jan. 5, 2023

(51) Int. Cl. A47J 47/01

(52) U.S. Cl. CPC A47J 47/01

(57) ABSTRACT

A seasoning box and a mounting assembly thereof are provided. The seasoning box includes a box body; the box body is provided with a first accommodating cavity and a mounting cavity; an elastic resetting member and a baffle plate are arranged in the mounting cavity; a first discharging hole is formed in a lower side of the first accommodating cavity; the baffle plate is provided with a second discharging hole; furthermore, the elastic resetting member is in driving connection with the baffle plate; the baffle plate is arranged in the mounting cavity in a back and forth reciprocating movement manner; and the baffle plate downwards extends to form a push plate.

### TECHNICAL FIELD

The present disclosure relates to a seasoning box and a mounting assembly thereof.

### BACKGROUND

The statements here only provide the background information related to the present disclosure, and do not necessarily constitute the prior art.

Seasonings are indispensable in a cooking process. In order to properly place the seasonings, there are various kinds of seasoning boxes, including separate seasoning boxes and combined seasoning boxes. According to an overall design, a seasoning box is a container for storing a seasoning, which is provided with a lid and a spoon for taking out the seasoning. However, this kind of seasoning box needs to be opened and closed frequently during use, which is troublesome. If there is oil stain on the hand, the seasoning box will be stained with the oil stain, making the seasoning box inconvenient to clean. In the process of taking out the seasonings with the spoon, the seasonings may be often scattered on a cooking bench, making the kitchen in a mess. After the seasoning box is used for a long time, the seasonings in it will be affected with damp since the seasoning box is frequently opened and closed, resulting in impact on the quality of the seasonings.

Later, there is a seasoning box that discharges seasonings and closes a valve by means of pushing a fixed plate. For example, in the Chinese patent No. CN217885826U, a fixed plate is moved, so that a through hole on the fixed plate is staggered from or opposite to a through hole on the seasoning box to realize discharging of the seasonings and closing of the seasoning box.

However, this seasoning box also has some shortcomings. The fixed plate is arranged at a lower end of the seasoning box, and the seasoning box is not used to limit and guide the movement of the fixed plate, which leads to the problem of movement stagnation and poor reliability during use.

Secondly, there is no corresponding optimization inside the seasoning box, and the problem of unsmooth discharging also easily occurs in the subsequent use process.

Therefore, it is necessary to study a new technical solution to solve the above problems.

### SUMMARY

In order to solve the defects and shortcomings in the prior art, the present disclosure provides a seasoning box and a mounting assembly thereof. Compared with the existing seasoning box, the seasoning box of the improved design is better in discharging stability and reliability. Furthermore, a push-discharging design also has a reasonable and stable advantage. Meanwhile, the seasoning box of the present disclosure is simple and ingenious in overall design and has the advantage of low production cost.

In order to achieve the above-mentioned objective, the present disclosure adopts the following technical solution:

A seasoning box includes a box body, wherein the box body is provided with a first accommodating cavity used for placing seasonings; a mounting cavity is arranged on a lower side of the first accommodating cavity; an elastic resetting member and a baffle plate are arranged in the mounting cavity; a first discharging hole is formed in the lower side of the first accommodating cavity; the baffle plate is provided with a second discharging hole corresponding to the first discharging hole; furthermore, the elastic resetting member is in driving connection with the baffle plate; the baffle plate is arranged in the mounting cavity in a back and forth reciprocating movement manner; and the baffle plate downwards extends to form a push plate.

In some embodiments, the elastic resetting member is a spring; a mounting pillar is arranged at a rear end of the baffle plate; the spring sleeves the mounting pillar; and one end of the spring far from the baffle plate is fixedly connected to the box body.

In some embodiments, two mounting pillars are arranged on a rear side of the baffle plate along a left-right direction.

In some embodiments, a toggle wheel is arranged in the first accommodating cavity; a lower end of the toggle wheel is connected with a drive wheel; the drive wheel is located in the mounting cavity; and the baffle plate is provided with a drive protrusion corresponding to the drive wheel.

In some embodiments, the toggle wheel is provided with several toggle rods which are circumferentially arranged; the drive wheel is provided with a drive tooth groove; and the drive protrusion is located in the drive tooth groove.

In some embodiments, an upper end of the first accommodating cavity of the box body is detachably connected with an upper cover.

In some embodiments, a lower end of an inner side wall of the first accommodating cavity is provided with a guide slope.

A seasoning box and a mounting assembly thereof include a seasoning box and a wall-mounted member; the seasoning box is the foregoing seasoning box; and the wall-mounted member is provided with a mounting hole connected to a wall.

A groove matched with the wall-mounted member is arranged on a rear side of the box body; a fixing slot is arranged in the groove; and the wall-mounted member is provided with a fixing clip matched with the fixing slot.

In some embodiments, a width of the fixing slot gradually increases from top to bottom, and correspondingly, a width of the fixing clip gradually increases from top to bottom.

Compared with the prior art, the present disclosure has obvious advantages and beneficial effects. Specifically, according to the above technical solution, compared with the existing seasoning box, the seasoning box of the improved design is better in discharging stability and reliability. Furthermore, a push-discharging design also has a reasonable and stable advantage. Meanwhile, the seasoning box of the present disclosure is simple and ingenious in overall design and has the advantage of low production cost.

Secondly, due to the structural design of the toggle wheel and the design of the guide slope, the seasoning box also has the advantage of further improving the discharging smoothness, and solves the problem in the traditional technology that the seasonings are easy to accumulate in the accommodating cavity and will not flow.

In order to describe the structural features and effects of the present disclosure more clearly, the present disclosure is described in detail below in combination with the accompanying drawings and specific embodiments.

### BRIEF DESCRIPTION OF THE DRAWINGS

FIG. 1 is a schematic three-dimensional diagram of an embodiment of the present disclosure;

FIG. 2 is a first schematic exploded diagram of an embodiment of the present disclosure;

FIG. 3 is a second schematic exploded diagram of an embodiment of the present disclosure;

FIG. 4 is a schematic sectional diagram of an embodiment of the present disclosure;

FIG. 5 is a partially enlarged diagram of FIG. 4;

FIG. 6 is a third schematic exploded diagram of an embodiment of the present disclosure;

FIG. 7 is a partially enlarged diagram of FIG. 6;

FIG. 8 is a schematic diagram of a rough discharging principle of an embodiment of the present disclosure.

Reference numerals in the drawings:

10: box body; 11: first accommodating cavity; 111: first discharging hole; 112: guide slope; 12: mounting cavity; 13: upper cover; 14: groove; 15: fixing slot; 20: elastic resetting member; 30: baffle plate; 31: second discharging hole; 32: push plate; 33: mounting pillar; 34: drive protrusion; 40: toggle wheel; 41: toggle rod; 50: drive wheel; 51: drive tooth groove; 60: wall-mounted member; 61: and fixing clip.

### DETAILED DESCRIPTION OF THE EMBODIMENTS

The technical solutions in the embodiments of the present disclosure will be clearly and completely described below in conjunction with the accompanying drawings. Apparently, the described embodiments are only preferred embodiments of the present disclosure.

It should be noted that when an element is referred to as being “fixed” to another element, it can be directly on the other element or an intermediate element may also exist. When one element is considered to be “connected” to another element, it can be directly connected to another element or there may be a central element at the same time. The terms “perpendicular”, “horizontal”, “left”, “right” and similar expressions used herein are for illustrative purposes only, and are not meant to be the only implementation modes.

Unless otherwise defined, all technical and scientific terms used herein are the same as meanings of general understandings of those skilled in the art of the present disclosure. The terms used in the description of the present disclosure herein are merely to describe the specific implementation modes, not intended to limit the present disclosure. The term “and/or” used herein includes any and all combinations of one or more related listed items.

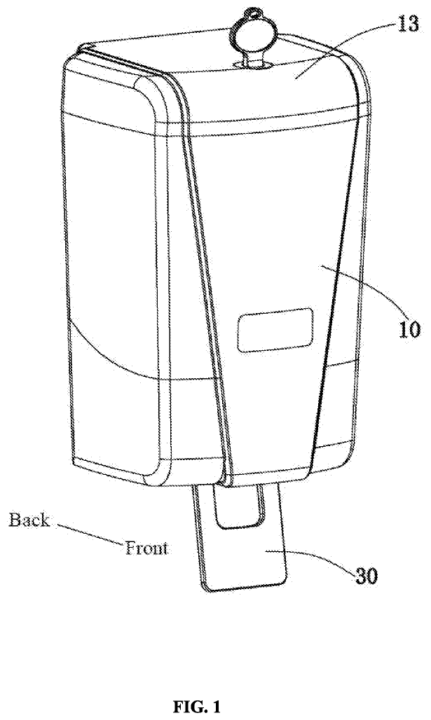

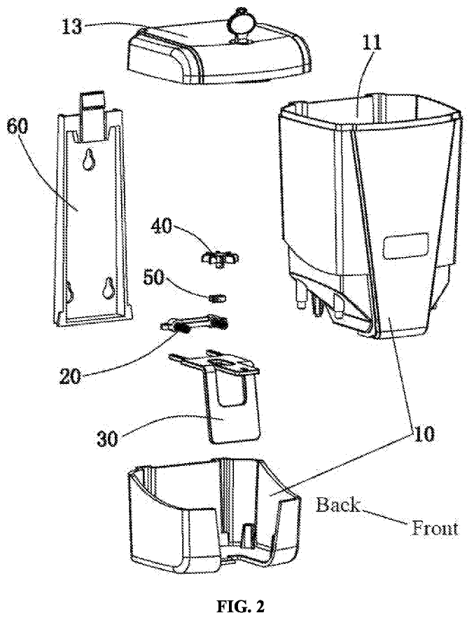

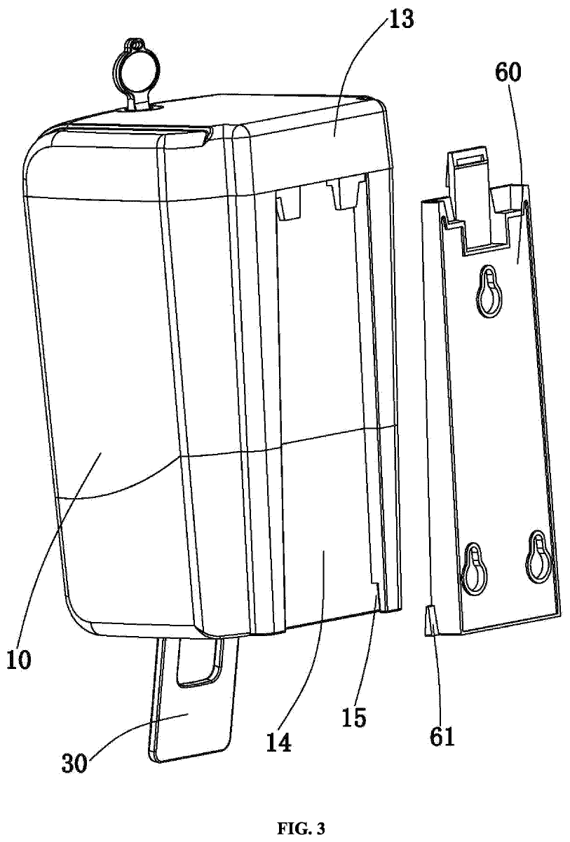

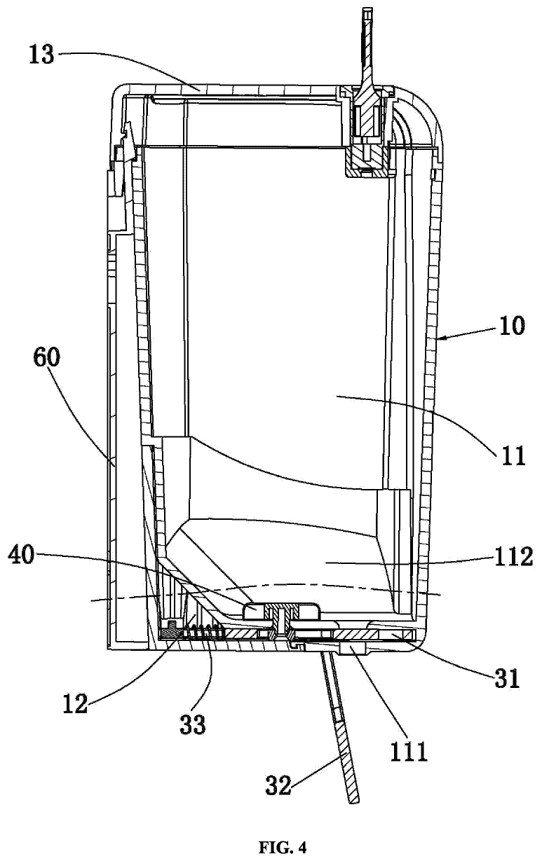

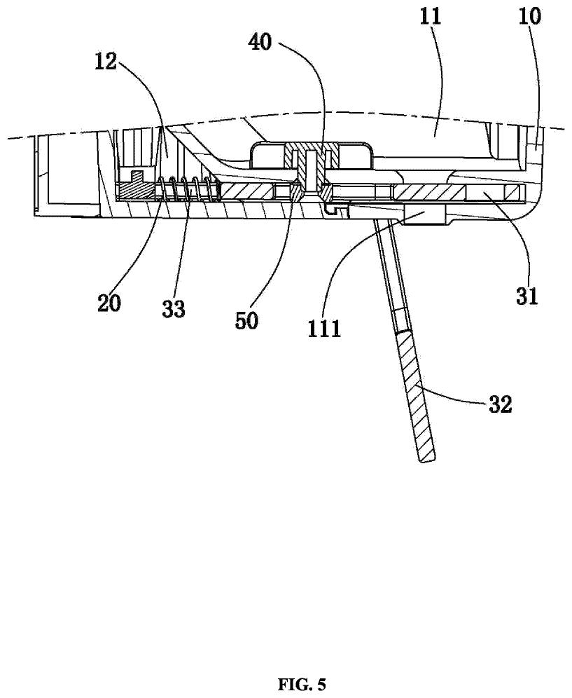

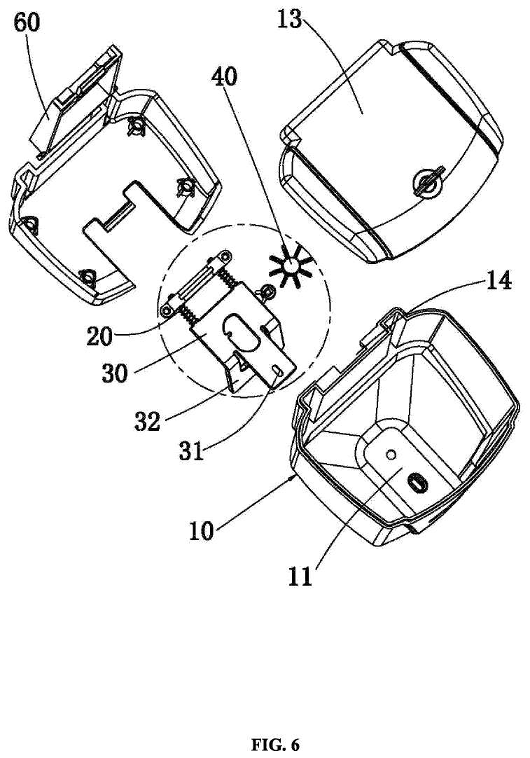

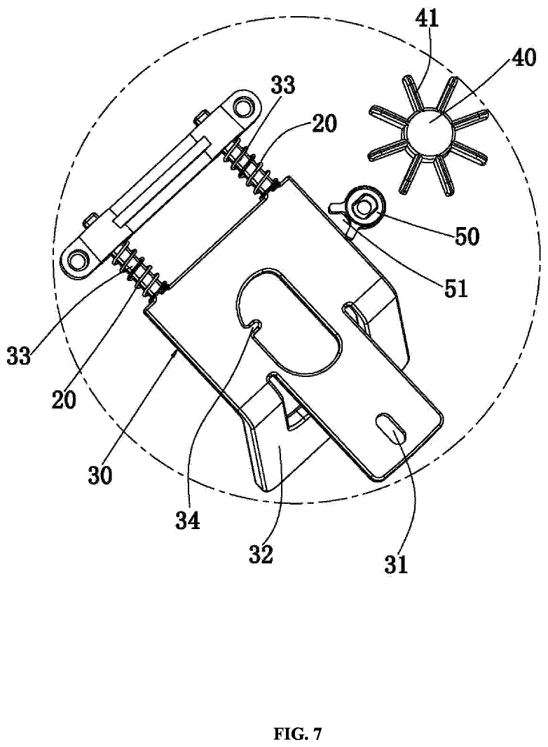

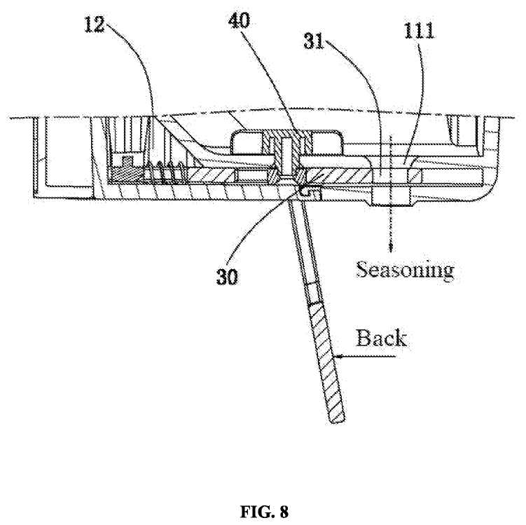

Referring to FIG. 1 to FIG. 8, a seasoning box and a mounting assembly thereof in the embodiments of the present disclosure include a box body 10. The box body 10 is provided with a first accommodating cavity 11 used for placing seasonings. A mounting cavity 12 is arranged on a lower side of the first accommodating cavity 11. An elastic resetting member 20 and a baffle plate 30 are arranged in the mounting cavity 12. A first discharging hole 111 is formed in the lower side of the first accommodating cavity 11. The baffle plate 30 is provided with a second discharging hole 31 corresponding to the first discharging hole 111. Furthermore, the elastic resetting member 20 is in driving connection with the baffle plate 30. The baffle plate 30 is arranged in the mounting cavity 12 in a back and forth reciprocating movement manner; and the baffle plate 30 downwards extends to form a push plate 32.

During use, tiny solid seasonings are stored in the first accommodating cavity 11. The baffle plate 30 is moved back and forth by means of pushing the push plate 32. When the second discharging hole 31 is located below the first discharging hole 111, the seasonings flow out of the box body 10 via the first discharging hole 111 and the second discharging hole 31 from the first accommodating cavity 11. When the first discharging hole 111 and the second discharging hole 31 are staggered, a portion of the baffle plate 30 except the second discharging hole 31 plays a role of closing the first discharging hole 111, so that the seasonings are closed in the first accommodating cavity 11 and will not flow out of the box body 10. In this way, the seasoning box of the present disclosure is ingenious in structure and easy to manufacture, and has the advantages of low manufacturing cost, convenience in operation, stable work and the like.

Preferably, the push plate 32 integrally extends forwards and downwards from the baffle plate 30, making it more convenient for a user to perform a push operation. Specifically, the elastic resetting member 20 is a spring; a mounting pillar 33 is arranged at a rear end of the baffle plate 30; the spring sleeves the mounting pillar 33; and one end of the spring far from the baffle plate 30 is fixedly connected to the box body 10. Preferably, two mounting pillars 33 are arranged on a rear side of the baffle plate 30 along a left-right direction. In this way, by means of arrangement of two springs which are respectively located on the left and right sides of the baffle plate 30, when the baffle plate 30 is pushed backward or pushed forward, a stress balance can be guaranteed, so that the baffle plate 30 can be horizontally pushed in and out. The moving process is smoother, and the working stability is better.

Preferably, a toggle wheel 40 is arranged in the first accommodating cavity 11; a lower end of the toggle wheel 40 is connected with a drive wheel 50; the drive wheel 50 is located in the mounting cavity 12; and the baffle plate 30 is provided with a drive protrusion 34 corresponding to the drive wheel 50. Specifically, the toggle wheel 40 is provided with several toggle rods 41 which are circumferentially arranged; the drive wheel 50 is provided with a drive tooth groove 51; and the drive protrusion 34 is located in the drive tooth groove 51. In this way, since the toggle wheel 40 is arranged in the first accommodating cavity 11 to toggle the seasonings, it is ensured that the seasonings can effectively flow out from the first discharging hole 111 and the second discharging hole 31, which further improves the practicability and reliability of the seasoning box. Meanwhile, the drive wheel 50 of the toggle wheel 40 is linked to the baffle plate 30, so that the working frequency of the toggle wheel 40 can be equal to the moving frequency of the baffle plate 30 without an additional drive mechanism, which eliminates unnecessary actions and greatly simplifies the structural design of the seasoning box. That is, the effective toggle efficiency of the toggle wheel 40 can be improved, and no great pressure is caused on the design of the seasoning box. It is very ingenious.

In actual applications, an upper end of the first accommodating cavity 11 of the box body 10 is detachably connected with an upper cover 13 through snap-fit or other structures. Thus, the upper cover 13 is opened to supplement seasonings. Of course, the upper end of the first accommodating cavity 11 of the box body 10 can also be rotatably connected with the upper cover 13 through a rotating shaft or other structures, so that it is convenient for a user to open the upper cover 13 to supplement seasonings.

As mentioned above, the first discharging hole 111 is formed in a bottom wall of the first accommodating cavity 11. Preferably, a guide slope 112 is arranged on a lower end of an inner side wall of the first accommodating cavity 11. Furthermore, the guide slope 112 tilts towards the first discharging hole 111, so as to guide the seasonings to the first discharging hole 111, which further improves the use reliability and stability of the seasoning box and solves the problem that excessive seasonings cannot flow out from the first accommodating cavity 11.

Further, the seasoning box further includes a wall-mounted member 60. The wall-mounted member 60 is provided with a mounting hole connected to a wall. A groove 14 matched with the wall-mounted member 60 is arranged on a rear side of the box body 10. A fixing slot 15 is arranged in the groove 14. The wall-mounted member 60 is provided with a fixing clip 61 matched with the fixing slot 15. Furthermore, the fixing slot 15 gradually increases from top to bottom, and the fixing clip 61 also gradually increases from top to bottom. In specific applications, one fixing slot 15 is arranged on each of the left side and the right side of the groove 14, and correspondingly, one fixing clip 61 is also arranged on each of the left side and the right side of the wall-mounted member 60.

The key point of the design of the present disclosure is mainly as follows. Compared with the existing seasoning box, the seasoning box of the improved design is better in discharging stability and reliability. Furthermore, a push-discharging design also has a reasonable and stable advantage. Meanwhile, the seasoning box of the present disclosure is simple and ingenious in overall design and has the advantage of low production cost.

Secondly, due to the structural design of the toggle wheel and the design of the guide slope, the seasoning box also has the advantage of further improving the discharging stability, and solves the problem in the traditional technology that the seasonings are easy to accumulate in the accommodating cavity.

The above descriptions are only preferred embodiments of the present disclosure, and do not limit the technical scope of the present disclosure. Therefore, any minor changes, equivalent changes and modifications made to the above embodiments according to the technical essence of the present disclosure still fall within the scope of the technical solutions of the present disclosure.

What is claimed is:

1. A seasoning box, comprising a box body, wherein the box body is provided with a first accommodating cavity used for placing seasonings; a mounting cavity is arranged on a lower side of the first accommodating cavity; an elastic resetting member and a baffle plate are arranged in the mounting cavity; a first discharging hole is formed in the lower side of the first accommodating cavity; the baffle plate is provided with a second discharging hole corresponding to the first discharging hole; furthermore, the elastic resetting member is in driving connection with the baffle plate; the baffle plate is arranged in the mounting cavity in a back and forth reciprocating movement manner; and the baffle plate downwards extends to form a push plate.

2. The seasoning box according to claim 1, wherein the elastic resetting member is a spring; a mounting pillar is arranged at a rear end of the baffle plate; the spring sleeves the mounting pillar; and one end of the spring far from the baffle plate is fixedly connected to the box body.

3. The seasoning box according to claim 2, wherein two mounting pillars are arranged on a rear side of the baffle plate along a left-right direction.

4. The seasoning box according to claim 2, wherein a toggle wheel is arranged in the first accommodating cavity; a lower end of the toggle wheel is connected with a drive wheel; the drive wheel is located in the mounting cavity; and the baffle plate is provided with a drive protrusion corresponding to the drive wheel.

5. The seasoning box according to claim 4, wherein the toggle wheel is provided with several toggle rods which are circumferentially arranged; the drive wheel is provided with a drive tooth groove; and the drive protrusion is located in the drive tooth groove.

6. The seasoning box according to claim 2, wherein an upper end of the first accommodating cavity of the box body is detachably connected with an upper cover.

7. The seasoning box according to claim 2, wherein a lower end of an inner side wall of the first accommodating cavity is provided with a guide slope.

8. A seasoning box and a mounting assembly thereof, comprising a seasoning box and a wall-mounted member, wherein the seasoning box is the seasoning box according to claim 1, and the wall-mounted member is provided with a mounting hole connected to a wall;
a groove matched with the wall-mounted member is arranged on a rear side of the box body; a fixing slot is arranged in the groove; and the wall-mounted member is provided with a fixing clip matched with the fixing slot.

9. The seasoning box and the mounting assembly thereof according to claim 8, wherein a width of the fixing slot gradually increases from top to bottom, and correspondingly, a width of the fixing clip gradually increases from top to bottom.
